(19) United States
(12) Patent Application Publication
(10) Pub. No.: US 2013/0203921 A1
(43) Pub. Date: Aug. 8, 2013

(54) THERMOPLASTIC POM COMPOSITION

(71) Applicant: BASF SE, Ludwigshafen (DE)

(72) Inventors: Laurence Pottie, Koln (DE); Bernd-Steffen von Bernstorff, Wachenheim (DE)

(73) Assignee: BASF SE, Ludwigshafen (DE)

(21) Appl. No.: 13/756,771

(22) Filed: Feb. 1, 2013

Related U.S. Application Data
(60) Provisional application No. 61/593,872, filed on Feb. 2, 2012.

(51) Int. Cl. C08L 71/02

(52) U.S. Cl. CPC C08L 71/02
USPC 524/407; 525/410

(57) ABSTRACT

The invention relates to thermoplastic compositions which comprise mixtures of polyoxymethylene homo- or copolymers, production of these, use of these for producing metallic or ceramic moldings, and the resultant moldings.

### CROSS-REFERENCE TO RELATED APPLICATIONS

This application claims benefit (under 35 USC 119(e)) of U.S. Provisional Application 61/593,872, filed Feb. 2, 2012, which is incorporated by reference.

The invention relates to thermoplastic compositions which comprise mixtures of polyoxymethylene homo- or copolymers, production of these, use of these for producing metallic or ceramic moldings, and the resultant moldings.

Polyoxymethylene homo- or copolymers, also termed polyacetal or polyformaldehyde, or POM, are generally high-molecular-weight thermoplastics which exhibit high stiffness, low coefficients of friction, and excellent dimensional stability and thermal stability. They are therefore used in particular for producing precision-engineered parts.

Properties which make them advantageously useful for applications involving moldings are in particular high strength, hardness, and stiffness over a wide temperature range. Further processing takes place by way of example by way of injection molding at temperatures in the range from 180 to 230° C., or else by extrusion. Polyoxymethylene is produced by way of example by direct polymerization of formaldehyde or by cationic or transition-metal-centered cationic polymerization of trioxane. For stabilization, the end groups are often protected by etherification or esterification in order to inhibit depolymerization on exposure to acid or to thermal stress.

Another possibility for stabilization to counter the effect of acid and of thermal stress is the production of copolymers, for example by copolymerizing trioxane with 1,4-dioxane. For stabilization here, the unstable end groups are decomposed by hydrolysis to give formaldehyde. Typical copolymers are available by way of example with trade marks Hostaform® from Ticona/Celanese and Ultraform® from BASF SE.

The melting point of the homopolymer is typically about 178° C., and that of the copolymer is typically about 166° C.

Processes for producing polyoxymethylene homo- or copolymers are described by way of example in WO 2007/023187 and WO 2009/077415.

U.S. Pat. No. 6,388,049 relates to polyoxymethylene polymers with low molecular weight and compositions comprising these.

Production examples 14 to 16 mention trioxane- and butanediol-formal-based copolymers in which methylal was used as regulator. The amount of comonomer added is in each case 1.46 mol %, corresponding to about 4.4% by weight of butanediol formal. Number-average molar masses obtained are 1100, 5500, and 35 000 g/mol.

Polyoxymethylene is also used as binder for powder injection molding. Here, POM molding compositions filled with inorganic powders, in particular metal powders or ceramic powders, are processed by injection molding to give moldings, and the binder is then removed and the products are sintered. Since the high loading of the inorganic powders in the POM impairs flowability, it is necessary to use POM compositions which are very flowable, in order to keep the pressures required in the injection molding process within acceptable bounds.

Polymer particles marketed with trademark Catamold® comprise inorganic powders, in particular metal powders or ceramic powders. Typically, these powders are first coated with a thin layer of polyethylene and then are compounded into a polyoxymethylene binder. These Catamold granules are then processed by injection molding to give a green product, converted to a brown product by removal of binder, and then sintered to give a sintered molding. The process is known as metal injection molding (MIM) and permits production of metallic or ceramic moldings with complex shapes.

The proportion of inorganic fillers in the Catamold granules is about 90% by weight.

The green products produced with use of polyoxymethylene homo- or copolymers have very good mechanical properties, in particular dimensional stability.

Binder removal is often achieved through exposure to an acidic atmosphere, for example HNO₃ atmosphere, at from 110 to 140° C., with decomposition of the POM binder. The thin polyethylene coating of the inorganic particles binds these to one another in the brown product obtained. The acidic depolymerization of the POM permits complete removal of the binder.

The brown product is preferably sintered in a sintering oven at temperatures in the range of about 1300 to 1500° C., to give the desired metal molding or ceramic molding.

Thermoplastic compositions suitable for the Catamold process for producing metallic moldings are described by way of example in EP-A-0 446 708.

Thermoplastic compositions for producing ceramic moldings are described by way of example in EP-A-0 444 475.

Molding compositions comprising metal oxides are described by way of example in EP-A-0 853 995.

The better the flowability of the filled polyoxymethylene homo- or copolymer compositions, the finer the structures that can be developed in the molding. On the other hand, the metal particles or ceramic particles have to be capable of homogeneous transportation with the molding composition. A suitable property profile involving flowability and creep compliance is often achieved by using POM with a weight-average molar mass starting at about 85 000 g/mol.

The flowability of the POM could be improved by reducing molecular weight, or flow improvers could be added. A flow improver here should have very good miscibility with POM and exhibit rapid decomposition in an acid-gas atmosphere, in order to avoid defects in the desired moldings.

EP-A-0 446 708 describes the addition of aliphatic polyurethanes, of aliphatic uncrosslinked polyepoxides, of aliphatic polyamides or polyacrylates, or of poly(C₂₋₆-alkylene oxides) to give polyoxymethylene homo- or copolymers.

It is an object of the present invention to provide thermoplastic molding compositions which are based on polyoxymethylene homo- or copolymers with improved flowability and which, when charged with inorganic powders in the extrusion process or in the injection-molding process exhibit better flow behavior than known molding compositions, and which at the same time retain the good mechanical properties of the known molding compositions based on polyoxymethylene homo- or copolymers.

The invention achieves the object through a thermoplastic composition comprising

from 10 to 90% by weight of a polyoxymethylene homo- or copolymer with a weight-average molar mass (M_{W}) in the range from 50 000 to 400 000 g/mol as component B1 and
from 10 to 90% by weight of a polyoxymethylene copolymer with a weight-average molar weight (M_{W}) in the range from 5000 to 15 000 g/mol as component B2 derived to an extent of at least 90% by weight, based on the polymer, from trioxane and butanediol formal as monomers, with a proportion of butanediol formal, based on the polymer, in the range from 0.5 to 4% by weight, preferably from 2 to 3.5% by weight, in particular 2.5 to 3% by weight.

The object is further achieved through a process for producing said thermoplastic compositions by separate production of components B1 and B2 in each case by polymerizing trioxane and optionally comonomers in the presence of at least one cationic initiator and of at least one di(C₁₋₆-alkyl) acetal as regulator, and then mixing components B1 and B2.

The object is further achieved by a process for producing flowable polyoxymethylene homo- or copolymers by separate production of components B1 and B2, this being as defined above, respectively by polymerizing trioxane and (in the case of component B1 optionally) comonomers in the presence of at least one cationic initiator and of at least one di(C₁₋₆-alkyl) acetal as regulator, and then mixing components B1 and B2 at a temperature in the range from 150 to 220° C. under a pressure in the range from 0.5 to 5 bar.

The object is also achieved through flowable polyoxymethylene copolymers which are obtainable by the above process.

The object is also achieved through a molding composition for producing inorganic moldings, comprising, based on the total volume of the molding composition,
from 20 to 70% by volume of a sinterable pulverulent inorganic material selected from metals, metal alloys, metal carbonyls, metal oxides, metal carbides, metal nitrides, and mixtures thereof, as component A,
from 30 to 80% by volume of a thermoplastic composition as defined above, or obtainable by the above process, as component B, and
from 0 to 5% by volume of a lubricant and/or dispersing agent as component C,
   where the total volume of components A to C gives 100% by volume.

The object is also achieved through a process for producing molding compositions of this type by melting component B at a temperature in the range from 150 to 220° C. to obtain a melt stream and metering components A and optionally C into the melt stream of component B.

The object is also achieved through the use of the above molding compositions for producing metallic or ceramic moldings.

The object is also achieved through a process for producing metallic or ceramic moldings by injection molding or extruding the molding composition to give a green product, then removing binder from the green product to give a brown product, and then sintering the brown product.

The object is also achieved through a molding produced from the molding compositions described above, or obtainable by the processes described above.

### A BRIEF DESCRIPTION OF THE FIGURES

FIG. 1 attached shows the dependency of the size-exclusion-chromatography (SEC) detector signal in arbitrary units when plotted against molar mass in g/mol. The continuous line shows the molar mass distribution for mixing for one minute, the triangles show the molar mass distribution after mixing for 2 minutes, and the circles show the molar mass distribution for a mixing time of 5 minutes.

FIG. 2 shows images of the resultant spirals.

### A DETAILED DESCRIPTION OF THE INVENTION

The expression “polyoxymethylene” or “polyoxymethylene homo- or copolymers” means a polyoxymethylene homopolymer and/or a polyoxymethylene copolymer.

In the invention, it has been found that polyoxymethylene copolymers with a weight-average molar mass (M_{W}) in the range from 5000 to 15 000 g/mol, preferably from 5000 to 10 000 g/mol, or from 6000 to 13 000 g/mol, with preference from 6000 to 9000 g/mol, or from 6500 to 11 000 g/mol, particularly preferably from 6500 to 8000 g/mol, in particular from 7000 to 7500 g/mol, derived to an extent of at least 90% by weight, based on the polymer, from trioxane and butanediol formal as monomers, with a proportion of butanediol formal, based on the polymer, in the range from 0.5 to 4% by weight, preferably from 1 to 4% by weight, with preference from 2 to 3.5% by weight, in particular from 2.5 to 3% by weight, can be used as viscosity-modifying additives for polyoxymethylene homo- or copolymers with higher molecular weight, without impairing the mechanical properties of the resultant blend or reaction product when comparison is made with polyoxymethylene homo- or copolymers with higher molecular weight.

Molecular weights can be determined here as described in the examples. The molecular weights are generally determined by way of gel permeation chromatography (GPC) or SEC (size exclusion chromatography). The number-average molecular weight is generally determined by GPC-SEC.

Component B2 is now described in more detail below.

It is preferable that the ratio between weight-average molecular weight (M_{W}) and number-average molecular weight (Mₙ), also termed polydispersity or M_{W}/Mₙ, is in the range from 1.5 to 3.0, preferably from 1.5 to 2.45.

As an alternative, which is preferred, the number-average molar mass (Mₙ) is preferably from 3000 to 6000 g/mol, particularly preferably from 3200 to 5000 g/mol, in particular from 3500 to 4100 g/mol. Within this molecular weight range, a particularly advantageous flow improvement is achieved for polyoxymethylene homo- or copolymers with higher molecular weight.

The use of a polyoxymethylene copolymer of the present invention, having a proportion of butanediol formal, based on the polymer, in the range from 1 to 4% by weight, reveals higher crystallinity and higher hardness despite the low molecular weight, because of the reduced proportion of comonomer in comparison with U.S. Pat. No. 6,388,049. The result here for polyoxymethylene homo- or copolymers with higher molecular weight is, despite good viscosity-reducing properties, advantageous hardness of these polymer mixtures and therefore advantageous mechanical properties for the application.

Very generally, polyoxymethylene copolymers (POM) of the invention have at least 50 mol % of —CH₂O— repeat units in the main polymer chain. Polyoxymethylene copolymers are preferred which also have, alongside the —CH₂O— repeat units, up to 50 mol %, preferably from 0.01 to 20 mol %, in particular from 0.1 to 10 mol %, and very particularly preferably from 0.5 to 6 mol %, of

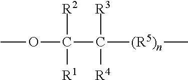

repeat units, where R¹ to R⁴ are mutually independently a hydrogen atom, a C₁-C₄-alkyl group, or a halogen-substituted alkyl group having from 1 to 4 carbon atoms, and R⁵ is —CH₂—, —CH₂O—, or a C₁-C₄-alkyl or C₁-C₄-haloalkyl-substituted methylene group, or a corresponding oxymethylene group, and n has a value in the range from 0 to 3. Said groups can advantageously be introduced into the copolymers through ring-opening of cyclic ethers. Preferred cyclic ethers are those of the formula

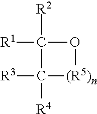

where R¹ to R⁵ and n are as defined above. Merely by way of example, ethylene oxide, propylene 1,2-oxide, butylene 1,2-oxide, butylene 1,3-oxide, 1,3-dioxane, 1,3-dioxolane, and 1,3-dioxepane (=butanediol formal, BUFO) may be mentioned as cyclic ethers, and linear oligo- or polyformals, such as polydioxolane or polydioxepane, may be mentioned as comonomers.

Equally suitable materials are oxymethylene terpolymers which by way of example are produced through reaction of trioxane or of one of the cyclic ethers described above with a third monomer, preferably bifunctional compounds, of the formula

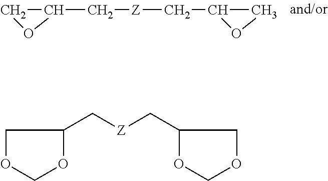

where Z is a chemical bond —O—, —ORO—(R═C₁-C₈-alkylene or C₃-C₈-cycloalkylene).

Preferred monomers of this type are ethylene diglycide, diglycidyl ether, and diethers derived from glycidyl compounds and formaldehyde, dioxane, or trioxane in a molar ratio of 2:1, and also diethers made of 2 mol of glycidyl compound and 1 mol of an aliphatic diol having from 2 to 8 carbon atoms, for example the diglycidyl ethers of ethylene glycol, 1,4-butanediol, 1,3-butanediol, cyclobutane-1,3-diol, 1,2-propanediol and cyclohexane-1,4-diol, to mention just a few examples.

Particular preference is given to end-group-stabilized polyoxymethylene polymers which have predominantly C—C or —O—CH₃ bonds at the chain ends.

At least 90% by weight of the polymers of the invention, based on the polymer, derive from trioxane and butanediol formal as monomers.

The polyoxymethylene copolymers derive, preferably exclusively, from trioxane and butanediol formal as monomers, with a proportion of butanediol formal, based on the polymer or on the monomers, in the range from 0.5 to 4% by weight, preferably from 1 to 4% by weight, with preference from 2 to 3.5% by weight, in particular from 2.5 to 3% by weight.

The molecular weights of the polymer can be adjusted to the desired values by using the regulators conventionally used in trioxane polymerization or else by using the reaction temperature and reaction residence time. Regulators that can be used are acetals and, respectively, formals of monohydric alcohols, the alcohols themselves, and also the small amounts of water which are generally inevitably present and which function as chain-transfer agents.

It is preferable that the chain ends of the polymer of the invention have, based on the polymer, from 3 to 6% by weight of moieties of the general formula —OR, where R is C₁₋₆-alkyl, preferably C₁₋₄-alkyl.

It is preferable that production of the polyoxymethylene copolymer of the invention uses, based on the polymer or on the entirety of monomers and regulator, from 3.75 to 4.25% by weight, preferably from 3.8 to 4.2% by weight, in particular from 3.9 to 4.1% by weight, of methylal, or an equimolar amount of another di(C₁₋₆-alkyl) acetal, concomitantly as regulator.

It is particularly preferable that, for example, on a laboratory scale, methylal is used concomitantly as regulator, or, for example industrially, that butylal (n-butylal) is used concomitantly as regulator.

It is particularly preferable to use butylal (n-butylal) as regulator with the advantage that it is nontoxic, whereas methylal is classified as toxic. The use of butylal as regulator represents a further advantage in comparison with the polyoxymethylene copolymers known from U.S. Pat. No. 6,388,049.

It is therefore preferable to use butylal as regulator in the production of the polymer. It is preferable to use an amount of from 0.5 to 4% by weight, based on the polymer, particularly from 1 to 3.5% by weight, in particular from 1.5 to 2.5% by weight, of butylal.

In conjunction with the specific amount of comonomer and with the specific molecular weight, polyoxymethylene copolymers are obtained with particularly suitable mechanical properties which make them suitable as viscosity-modifying additive for polyoxymethylene homo- or copolymers with higher molecular weight, without any major impairment of mechanical properties, in particular hardness.

Particular preference is therefore given to polyoxymethylene copolymers having a proportion of butanediol formal, based on the polymer, in the range from 0.5 to 4% by weight, preferably from 1 to 4% by weight, with preference from 2 to 3.5% by weight, in particular from 2.5 to 3% by weight, where production of these uses an amount of butylal, based on the polymer, of from 0.5 to 4% by weight, particularly preferably from 1 to 3.5% by weight, in particular from 1.5 to 2.5% by weight, concomitantly as regulator. The number average of the polyoxymethylene copolymer here is particularly preferably from 3000 to 6000 g/mol, more preferably from 3200 to 5000 g/mol, in particular from 3500 to 4100 g/mol.

This specific combination of molecular weight, proportion of comonomer, selection of comonomer, proportion of regulator, and selection of regulator leads to particularly suitable mechanical properties, which permit the advantageous use as viscosity-modifying additive for higher-molecular-weight polyoxymethylene homo- or copolymers.

Initiators used (also termed catalysts) are the cationic initiators conventional in trioxane polymerization. Protic acids are suitable, for example fluorinated or chlorinated alkyl- and arylsulfonic acids, examples being perchloric acid and trifluoromethanesulfonic acid, or Lewis acids, e.g. tin tetrachloride, arsenic pentafluoride, phosphorus pentafluoride, and boron trifluoride, as also are their complex compounds and salt-like compounds, examples being boron trifluoride etherates and triphenylmethyl hexafluorophosphate. The amounts used of the initiators (catalysts) are about 0.01 to 1000 ppm, preferably 0.01 to 500 ppm, and in particular from 0.01 to 200 ppm. It is generally advisable to add the initiator in dilute form, preferably at concentrations of from 0.005 to 5% by weight. Solvents used for this purpose can be inert compounds, such as aliphatic or cycloaliphatic hydrocarbons, e.g. cyclohexane, halogenated aliphatic hydrocarbons, glycol ethers, etc. Triglyme (triethylene glycol dimethyl ether) and 1,4-dioxane are particularly preferred as solvents.

The invention particularly preferably uses, as cationic initiators, an amount in the range from 0.01 to 1 ppm (preferably from 0.02 to 0.2 ppm, in particular from 0.04 to 0.1 ppm), based on the entirety of monomers and regulator, of Brönsted acids. In particular, HClO₄ is used as cationic initiator.

In addition to the initiators, cocatalysts can be used concomitantly. These are alcohols of any type, examples being aliphatic alcohols having from 2 to 20 carbon atoms, such as tert-amyl alcohol, methanol, ethanol, propanol, butanol, pentanol, hexanol; aromatic alcohols having from 2 to 30 carbon atoms, such as hydroquinone; halogenated alcohols having from 2 to 20 carbon atoms, such as hexafluoroisopropanol; very particular preference is given to glycols of any type, in particular diethylene glycol and triethylene glycol; and aliphatic dihydroxy compounds, in particular diols having from 2 to 6 carbon atoms, such as 1,2-ethanediol, 1,3-propanediol, 1,4-butanediol, 1,6-hexanediol, 1,4-hexanediol, 1,4-cyclohexanediol, 1,4-cyclohexanedimethanol, and neopentyl glycol.

Monomers, initiators, cocatalyst, and optionally regulator can be premixed in any desired manner, or else can be added separately from one another to the polymerization reactor.

The components for stabilization can moreover comprise sterically hindered phenols, as described in EP-A 129369 or EP-A 128739.

The polyoxymethylene copolymers of component B2 of the invention are produced by polymerization of trioxane, butanediol formal and optionally further comonomers in the presence of at least one cationic initiator and of at least one di(C₁₋₆-alkyl) acetal as regulator.

It is preferable that the polymerization mixture is deactivated, preferably without any phase change, directly after the polymerization reaction. The initiator residues (catalyst residues) are generally deactivated by adding deactivators (terminators) to the polymerization melt. Examples of suitable deactivators are ammonia, and also primary, secondary, or tertiary, aliphatic and aromatic amines, e.g. trialkylamines, such as triethylamine, or triacetonediamine. Other suitable compounds are salts which react as bases, for example soda and borax, and also the carbonates and hydroxides of the alkali metals and of the alkaline earth metals, and moreover also alcoholates, such as sodium ethanolate. The amounts of the deactivators usually added to the polymers are preferably from 0.01 ppmw (parts per million by weight) to 2% by weight. Preference is further given to alkyl compounds of alkali metals and of alkaline earth metals as deactivators, where these have from 2 to 30 carbon atoms in the alkyl moiety. Li, Mg, and Na may be mentioned as particularly preferred metals, and particular preference is given to n-butyllithium here.

In one embodiment of the invention, from 3 to 30 ppm, preferably from 5 to 20 ppm, in particular from 8 to 15 ppm, based on the entirety of monomers and regulator, of a chain terminator can be used concomitantly. Sodium methoxide is in particular used as chain terminator here.

POM made of trioxane and butanediol formal is generally obtained by polymerization in bulk, and any reactors with a high level of mixing action can be used for this purpose. The reaction here can be conducted homogeneously, e.g. in a melt, or heterogeneously, e.g. as polymerization to give a solid or solid granules. Examples of suitable equipment are tray reactors, plowshare mixers, tubular reactors, list reactors, kneaders (e.g. Buss kneaders), extruders, for example those having one or two screws, and stirred reactors, and the reactors here may have static or dynamic mixers.

Trioxane polymerization can be separated theoretically into three reaction steps, initiation, propagation, and transfer reactions. During the transfer reactions, chain transfer can take place to the polymer, to a protic species, such as water, or to a transfer agent, such as butylal. The transfer reactions to other polymer chains permit random distribution of the comonomer units along the polymer chains. These reactions occur between the carbonium of an active chain and the oxygen of another polymer chain, as long as active carbonium ions are present in the reaction mixture.

Transfer reactions to protic species, such as water, reduce the molecular weight of the polymer and also its thermal stability, since unstable hydroxy end groups are formed. The polymerization reaction is therefore carried out under the driest possible conditions.

Transfer reactions to aprotic species, such as acetals with low molecular weight, reduce molecular weight and produce stable ether end groups, and therefore increase the thermal stability of the polymer. It is therefore preferable to use chain-transfer agents or regulators such as methylal or butylal, the desired amount of which is added to the monomer mixture. Butylal content in the POM used in conventional Catamold compositions is generally about 0.35% by weight, and the weight-average molar mass of the POM is about 97 000 g/mol, with a M_{W}/Mₙ ratio of about 4.2.

The POM polymerization reaction has no termination step. The living polymer is in equilibrium with formaldehyde monomer until the system arrives at a comonomer end group which represents a stable end group. A method for stabilizing the ends of the polymer here is therefore depolymerization of the unstable chain ends until only stable comonomer end groups remain. This method is used in the circulatory tray process, in which most of the resultant polymers have end groups derived from methylal or butylal (e.g. —O—(CH₂)₄—OH). The chain ends can also be deactivated by adding an alkaline compound. This procedure is used in particular in continuous processes in which living end groups are typically deactivated with sodium methanolate. The resultant polymer has a majority of —CH₂—O—CH₃— end groups.

In the case of polymerization in bulk, e.g. in an extruder, the molten polymer produces an effect known as melt-sealing, as a result of which volatile constituents remain in the extruder. At a preferred reaction-mixture temperature of from 62 to 114° C., the above monomers are metered, together with or separately from the initiators (catalysts) into the polymer melt present in the extruder. It is preferable that the monomers (trioxane) are also metered in the molten state, e.g. at from 60 to 120° C. Because the process is exothermic, it is usually only at the start of the process that the polymer in the extruder has to be melted; the amount of heat generated is then sufficient to melt the resultant POM polymer, or to keep it molten.

Polymerization in the melt generally takes place at from 1.5 to 500 bar and 130 to 300° C., and the residence time of the polymerization mixture in the reactor is usually from 0.1 to 20 min, preferably from 0.4 to 5 min. It is preferable to carry out the polymerization reaction until conversion is above 30%, e.g. from 60 to 90%.

A crude POM is often obtained which, as mentioned, comprises considerable proportions, for example up to 40%, of unreacted residual monomers, in particular trioxane and formaldehyde. It is also possible that formaldehyde is present in the crude POM here even when only trioxane has been used as monomer, since it can arise as decomposition product of the trioxane. Other oligomers of formaldehyde can moreover also be present, e.g. the tetramer tetroxane.

Said crude POM is preferably devolatilized in one or more stages in known devolatilization apparatuses, for example in flash pots, vented extruders with one or more screws, thin-film evaporators, spray dryers, or other conventional devolatilization apparatuses. Flash pots are particularly preferred.

In a preferred method for the devolatilization of the crude POM, the material is devolatilized to below 6 bar absolute in a first flash, giving a gaseous stream and a liquid stream which is passed onward to a second flash operated at below 2 bar absolute to give a vapor stream which is recycled into the monomer plant.

By way of example, in the case of two-stage devolatilization, the pressure in the first stage can preferably be from 2 to 18 bar, in particular from 2 to 15 bar, and particularly preferably from 2 to 10 bar, and the pressure in the second stage can preferably be from 1.05 to 4 bar, in particular from 1.05 to 3.05 bar, and particularly preferably from 1.05 to 3 bar.

The partially devolatilized polyoxymethylene homo- or copolymer can then be introduced into an extruder or kneader and provided therein with conventional additional materials and processing aids (additives) in the amounts conventional for these substances. Examples of additives of this type are lubricants or mold-release agents, colorants, e.g. pigments or dyes, flame retardants, antioxidants, light stabilizers, formaldehyde scavengers, polyamides, nucleating agents, fibrous and pulverulent fillers or fibrous and pulverulent reinforcing materials, or antistatic agents, and also other additional materials or a mixture of these.

POM in the form of finished product is obtained as melt from the extruder or kneader.

The preferred batch synthesis using the circulatory tray process includes the following steps:

In the first step, the liquid monomer/comonomer mixture is charged to an unsealed reaction vessel (“tray”). Initiator is introduced through a pump, for example an HPLC pump, at a temperature in a range which is preferably from 60 to 100° C., particularly preferably from 70 to 90° C., in particular from 75 to 85° C. A solvent of boiling point above 100° C., miscible with the monomers, can be used concomitantly.

In the second step, the initiator, preferably aqueous HClO₄, is mixed in a solvent with the monomers.

In the third step, after an induction time, polymerization and crystallization take place simultaneously, and when these end the product of the homogeneous reaction is a solid block of polymer. The induction time here is often less than 120 seconds, for example from 20 to 60 seconds.

In the fourth step, the solid crude POM is removed from the tray, comminuted mechanically, and further processed in an extruder in order, for example, to obtain stable end groups through depolymerization (devolatilization). Stabilizers and other ingredients can also be metered into the material. A mixture which can be considered to be a standard stabilizer mixture is composed of antioxidant, acid scavenger, and nucleating agent.

Once the reaction vessel has been emptied, liquid monomer can again be charged thereto, in order to begin a new circuit.

Unlike in the process of the invention, the production process for the POM copolymers in U.S. Pat. No. 6,388,049 takes place in the fully molten state in tubular reactors. Blend production takes place in two reactors connected in series.

The resultant polymer can by way of example be milled to give a coarse powder, sprayed with a buffer solution, and then introduced into the extruder. The buffer serves to neutralize residual acids in the melt.

For successful conduct of the circulatory tray process, the synthesis should be rapid, i.e. have a short induction period. The oligomers obtained should moreover be hardened rapidly and completely during the polymerization reaction, and should form a block of polymer which does not adhere excessively to the vessel wall.

The low-molecular-weight POM of component B2 can be produced particularly advantageously by using a small amount of initiator, a large amount of regulator, and capping the chain ends. The resultant POM with low molecular weight is not only heat-resistant but also chemicals-resistant, and its viscosity can be lower by a factor of up to 1000 when it is compared with a conventional POM with high molecular weight, as used hitherto in Catamold compositions.

When the low-molecular-weight POM of component B2 is used as viscosity-modifying additive for POM with a weight-average molar mass of at least 50 000 g/mol, preferably at least 80 000 g/mol of component B1, the addition gives a POM system which is thermally and chemically stable and the viscosity of which can be reduced by a factor of at least 10, without significantly impairing the mechanical strength of the high-molecular-weight POM.

For the structure of component B1 and production thereof, reference may be made to the statements above relating to component B2, with the exception of the molecular weight, of the M_{W}/Mₙ ratio, and of the amounts of regulator and of cationic initiator. Furthermore, it is not necessary (but nevertheless preferred) that the comonomer butanediol formal is used concomitantly in component B1.

It is particularly preferable that both of components B1 and B2 are copolymers, in particular using the same comonomers in the same proportions of comonomer.

The weight-average molar mass (M_{W}) of the polyoxymethylene homo- or copolymer of component B1 is in the range from 50 000 to 400 000 g/mol, preferably from 80 000 to 300 000 g/mol, in particular from 95 000 to 210 000 g/mol.

Its production preferably uses, based on the polymer, from 0.05 to 0.7% by weight, particularly from 0.07 to 0.5% by weight, in particular from 0.1 to 0.35% by weight, of butanediol formal. If another di(C₁₋₆-alkyl)al is used as regulator, a corresponding equivalent amount of the regulator is used.

The amount of cationic initiator in the production process is preferably from 0.05 to 2 ppm, particularly preferably from 0.1 to 1 ppm.

The M_{W}/Mₙ ratio of the resultant polyoxymethylene homo- or copolymers of component B1 is preferably in the range from 3.5 to 9, particularly from 4 to 8, in particular from 4.2 to 7.7.

In a first embodiment of the invention, the thermoplastic compositions of the invention use from 10 to 90% by weight, preferably from 10 to 70% by weight, in particular from 10 to 50% by weight, of component B1 and correspondingly from 10 to 90% by weight, preferably from 30 to 90% by weight, in particular from 50 to 90% by weight, component B2.

In a second embodiment, the thermoplastic compositions of the invention use from 70 to 99.5% by weight, preferably from 80 to 99% by weight, in particular from 90 to 98% by weight, of component B1 and correspondingly from 0.5 to 30% by weight, preferably from 1 to 20% by weight, in particular from 2 to 10% by weight, of component B2.

The thermoplastic compositions are produced by separate production of components B1 and B2 and then mixing the two components. The mixing here can be achieved in any desired suitable apparatuses, such as kneaders or extruders. It is possible here to begin with mechanical premixing of solid particulate components B1 and B2, and then to melt these together. It is also possible to melt component B1 in an extruder and to add component B2 to said melt. The mixing process preferably takes place at a temperature in the range from 150 to 220° C., in particular from 180 to 200° C., under a pressure in the range from 0.5 to 5 bar, in particular from 0.8 to 2 bar.

When components B1 and B2 are mixed under the conditions stated above, a chemical reaction of the two components, in particular transacetalization, can also occur alongside the mechanical mixing process. It is therefore not necessary that components B1 and B2 are present in the original form in the mixture after the mixing process; instead, they can have been reacted to some extent or entirely to give a uniform or altered product. If a homopolymer is used as component B1, addition of component B2 and reaction thereof can give a uniform or altered copolymer.

The invention therefore also provides a process for producing flowable polyoxymethylene copolymers by separate production of components B1 and B2, these being as defined above, respectively by polymerizing trioxane and (in the case of B1 optionally) comonomers in the presence of at least one cationic initiator and of at least one di(C₁₋₆-alkyl) acetal as regulator, and then mixing components B1 and B2 at a temperature in the range from 150 to 220° C. under a pressure in the range from 0.5 to 5 bar, and the resultant polyoxymethylene homo- or copolymers.

The thermoplastic compositions are preferably used in the invention for producing molding compositions which serve for producing inorganic moldings. To this end, the thermoplastic compositions are filled with sinterable pulverulent inorganic material. Corresponding filled thermoplastic compositions are known per se from the prior art with use of other polyoxymethylene homo- or copolymers or merely with use of component B2 in the thermoplastic composition. Reference may be made by way of example to EP-A-0 444 475, EP-A-0 446 708, or EP-A-0 853 995 for a description of the corresponding molding compositions.

A corresponding molding composition of the invention for producing inorganic moldings comprises, based on the total volume of the molding composition,
from 20 to 70% by volume of a sinterable pulverulent inorganic material selected from metals, metal alloys, metal carbonyls, metal oxides, metal carbides, metal nitrides, and mixtures thereof, as component A,
from 30 to 80% by volume of a thermoplastic composition as described above, or obtainable by the above process, as component B, and
from 0 to 5% by volume of a lubricant and/or dispersing agent as component C,
   where the total volume of components A to C gives 100% by volume.

When a pulverulent metal or a pulverulent metal alloy or a mixture of these is used, the amount present in the molding compositions is preferably from 40 to 65% by volume, particularly preferably from 45 to 60% by volume, of component A.

Examples that may be mentioned of metals that can be comprised in powder form are iron, cobalt, nickel, and silicon. Examples of alloys are light-metal alloys based on aluminum and titanium, and also alloys with copper or bronze. It is also possible to use hard metals, such as tungsten carbide, boron carbide, or titanium nitride, in combination with metals such as cobalt and nickel. The latter can in particular be used when producing hard metal-bound cutting tools (known as cermets).

Corresponding amounts are used when metal carbonyls are used.

When metal oxides, metal carbides, metal nitrides, or a mixture thereof are used, the amount preferably used of the respective pulverulent inorganic material is from 20 to 50% by volume, particularly from 25 to 45% by volume, in particular from 30 to 40% by volume.

Suitable metal oxides are those which are hydrogen-reducible and sinterable, so that they can be used to produce metal moldings by heating in a hydrogen atmosphere or in the presence of hydrogen. Examples of metals of which the oxides can be used are found in groups VIB, VIII, IB, IIB, IVA of the Periodic Table of the Elements. Examples of suitable metal oxides are Fe₂O₃, FeO, Fe₃O₄, NiO, CoO, Co₃O₄, CuO, Cu₂O, Ag₂O, WO₃, MoO₃, SnO, SnO₂, CdO, PbO, Pb₃O₄, PbO₂, Cr₂O₃. It is preferable to use the lower oxides, for example Cu₂O instead of CuO, and PbO instead of PbO₂, since the higher oxides are oxidants which under certain conditions by way of example can react with organic binders. The oxides can be used individually or in the form of a mixture. It is therefore possible by way of example to obtain pure iron moldings or pure copper moldings. When mixtures of the oxides are used it is possible by way of example to obtain alloys and doped metals. By way of example, iron oxide/nickel oxide/molybdenum oxide mixtures are used to produce steel parts, and copper oxide/tin oxide mixtures, which can also comprise zinc oxide, nickel oxide, or lead oxide are used to produce bronzes. Particularly preferred metal oxides are iron oxide, nickel oxide, and/or molybdenum oxide.

The metal oxides used in the invention with a particle size of at most 50 μm, preferably at most 30 μm, particularly preferably at most 10 μm, in particular at most 5 μm, can be produced by various processes, preferably by chemical reactions. Solutions of metal salts can be used by way of example to precipitate the hydroxides, oxide hydrates, carbonates, or oxalates, whereupon optionally in the presence of dispersing agents the particles form very fine precipitates. The precipitates are isolated and brought to maximum purity level by washing. The precipitated particles are dried by heating, and are converted to the metal oxides at elevated temperatures.

It is also possible to arrive at very fine-particle metal oxides directly in a single step. By way of example, pentacarbonyliron is ignited in the presence of oxygen to obtain extremely fine, spherical iron oxide particles with specific surface areas of up to 200 m²/g.

The BET surface area of the metal oxides used in the invention, or at least 65% by volume of the powder, is preferably at least 5 m²/g, preferably at least 7 m²/g.

It is also possible that, alongside the hydrogen-reducible metal oxides, other metal compounds not reducible during the sintering process are present, for example non-hydrogen-reducible metal oxides, metal carbides, or metal nitrides. Examples of oxides here are ZrO₂, Al₂O₃, or TiO₂. Examples of carbides are SiC, WC, or TiC. An example of a nitride is TiN.

When sinterable inorganic nonmetallic powders are used as component A, the proportion is preferably from 40 to 65% by volume, particularly from 40 to 60% by volume.

Preferred powders of this type are oxidic ceramic powders, such as Al₂O₃, ZrO₂, and Y₂O₃, and also non-oxidic ceramic powders, such as SiC, Si₃N₄, TiB, and AlN, which may be used individually or in the form of a mixture. The average grain size of these powders is preferably from 0.1 to 50 μm, particularly preferably from 0.1 to 30 μm, in particular from 0.2 to 10 μm.

The corresponding sinterable pulverulent inorganic materials can also be produced as described EP-A-1 717 539 and DE-T1-100 84 853.

Spherical metal particles can be produced by chemical processes, or by passage through a nozzle with inert gases.

In one embodiment of the invention, the particle size of at least 65% by volume of component A is at most 5 μm, preferably at most 1.5 μm, in particular at most 0.5 μm, and the particle size of the remainder of component A is at most 10 μm, preferably at most 3 μm, in particular at most 1 μm.

The molding compositions of the invention can comprise from 0 to 5% by volume of a lubricant and/or dispersing agent as component C. When component C is used concomitantly, the proportion thereof is preferably from 0.2 to 5% by volume, particularly from 1 to 5% by volume. Examples of suitable dispersing agents are oligomeric polyethylene oxides with an average molecular weight in the range from 200 to 1000, preferably from 200 to 600, stearic acid, hydroxystearic acid, fatty alcohols, fatty alcohol sulfonates, and block copolymers of ethylene oxide and propylene oxide. Component A preferably comprises the dispersing agent(s) C on the surface.

Alkoxylated fatty alcohols or alkoxylated fatty acid amides are particularly suitable for dispersing metal oxide particles.

Examples of suitable lubricants are poly-1,3-dioxepane —O—CH₂—O—CH₂—CH₂—CH₂—CH₂—, poly-1,3-dioxolane —O—CH₂—O—CH₂—CH₂—, or a mixture of these, preferably in an amount of from 0.2 to 20% by weight, with preference from 0.5 to 10% by weight, with particular preference from 0.5 to 5% by weight, based on the amount of the binder B. Poly-1,3-dioxepane is particularly preferred under acidic conditions because of its rapid depolymerization.

Poly-1,3-dioxepane, also known as polybutanediol formal or polyBUFO, and poly-1,3-dioxolane can be produced by processes analogous to those for the polyoxymethylene homo- or copolymers, and there is therefore no need for further details here. The molecular weight (weight-average) is generally in the range from 10 000 to 150 000, preferably (in the case of poly-1,3-dioxepane) in the range from 15 000 to 50 000, particularly preferably (in the case of poly-1,3-dioxepane) in the range from 18 000 to 35 000, and preferably (in the case of poly-1,3-dioxolane) from 30 000 to 120 000, particularly preferably (in the case of poly-1,3-dioxolane) from 40 000 to 110 000.

Reference can moreover be made to component B₃) in WO 2008/006776 for a further description.

Under the conditions of compounding or injection molding, practically no transacetalization occurs between the polyoxymethylene polymers B and C, i.e. practically no exchange of comonomer units takes place.

The molding compositions of the invention can also comprise conventional additives and processing aids which have an advantageous effect on the rheological properties of the mixtures during the shaping process. Process stabilizers are particularly suitable.

The molding compositions are produced by melting component B at a temperature in the range from 150 to 220° C. to obtain a melt stream and metering components A and optionally C into the melt stream of component B. The molding compositions can be produced here in conventional mixing apparatuses, such as kneaders, mills, or extruders. In the case of blending in extruders, the mixture can be extruded and granulated. A particularly preferred apparatus for feeding component A comprises, as essential element, a conveying screw located in a heatable metal cylinder and conveying component A into the melt of component B.

The molding compositions are suitable for producing metallic or ceramic moldings. The production process uses injection molding or extrusion of the molding compositions to give a green product, then removing binder from the green product to give a brown product, and then sintering the brown product.

Removal of the binder here can be achieved by treating the green product with a gaseous acid-containing atmosphere at a temperature in the range from 20 to 180° C. for from 0.1 to 24 hours.

The metallic or ceramic moldings are produced here by the processes known from the prior art, these being by way of example as described in EP-A-0 444 475, EP-A-0 446 708, and EP-A-0 853 995. Reference may also be made to the processes described in EP-A-1 717 539 and DE-T1-100 84 853 for supplementary information.

In comparison with known molding compositions, the molding compositions of the invention feature improved flowability with retention of the advantageous mechanical properties, such as strength, hardness, and stiffness after cooling.

The examples below provide further explanation of the invention.

### EXAMPLES

### Production of the POM Oligomers (Component B2)

Laboratory-scale polymerization was carried out in a process which simulates the circulatory tray process. The monomers and the regulator were heated to 80° C. in open iron or aluminum reactors, with magnetic stirring. The mixture here was a transparent liquid. At a juncture t=0, an initiator solution was injected, composed of HClO₄ in triglyme, having a proton concentration which is typically 5 ppm relative to the monomers, or correspondingly lower for the low-molecular-weight POM. When polymerization was successful, the mixture became cloudy within a short time (induction period typically in the region of a few seconds to one minute) and the polymer precipitated.

### Post-Treatment and Determination of Weight Loss

The resultant block of polymer was then milled to give a powder and heated at reflux for one hour in an extraction solution made of methanol, water, and sodium carbonate. After cooling, the polymer was isolated by filtration and washed with a wash solution of aqueous sodium carbonate. The powder was then dried, and the weight loss was determined. This method gives an indication of the polymerization yield, since residual monomers or very low-molecular-weight oligomers are extracted in this step. The living centers of the crude polymer chains, and also residual acid centers, are to some extent extracted or neutralized. All of the cations should be neutralized, in order to obtain a polymer which has sufficient stability for further investigation or further processing. Otherwise acid residues would shift the equilibrium in the direction of formaldehyde and impair thermal stability.

### Investigation of Thermal Stability

A few grams of the extracted and dried polymer were heated under nitrogen to 220° C. After four hours, the weight loss from the polymer was determined. The result indicates how many unstable end groups are comprised by the polymer, affected by the amount and distribution of the comonomers along the polymer chain, and also by the amount of regulator.

### Thermal Stability

WL N₂: weight loss (WL) in percent from a specimen composed of 1.2 g of pellets on heating to 222° C. in nitrogen for 2 hours.

At the start of the WL determination process, the balance used for this purpose was tared. The specimen, in a twin-walled vessel composed of two test tubes, one placed inside the other (normal test tube, 100×10 mm; specially prepared, thick-walled test tube, 100×12.5 mm) was weighed out with accuracy of 0.1 mg.

A thin copper wire of length about 400 mm was secured to the upper lip of the outer tube. This was used to suspend the twin-walled vessel in a specific apparatus (see FIG. 9 and the relevant description of the figures in WO 2006/074997). For WL determination in nitrogen, the upper half of the apparatus was used for 15 min. for adaptation to the specific atmosphere, i.e. with no temperature increase. The test tubes were then lowered onto the base, where they were kept at 222° C. for 2 h. The nitrogen flow rate was 15 l/h, checked with the aid of a rota for each individual test tube.

After expiry of 2 h, the twin-walled vessels were withdrawn from the apparatus with the aid of the copper wire and cooled in air for from 20 to 25 min. The weight was then again measured on the balance, and WL was calculated from

WL[%]−(Loss×100/initial weight).

### Molar Mass Determination

The molar masses of the polymers were determined via size-exclusion chromatography in an SEC apparatus. This SEC apparatus was composed of the following combination of separating columns: a preliminary column of length 5 cm and diameter 7.5 mm, a second linear column of length 30 cm and diameter 7.5 mm. The separating material in both columns was PL-HFIP gel from Polymer Laboratories. The detector used comprised a differential refractometer from Agilent G1362 A. A mixture composed of hexafluoroisopropanol with 0.05% of potassium trifluoroacetate was used as eluent. The flow rate was 0.5 ml/min, the column temperature being 40° C. 60 microliters of a solution at a concentration of 1.5 g of specimen per liter of eluent were injected. This specimen solution had been filtered in advance through Millipor Millex GF (pore width 0.2 micrometers). Narrowly distributed PMMA standards from PSS (Mainz, DE) with molar masses M from 505 to 2 740 000 g/mol were used for calibration.

### Reactions Using Butylal as Regulator

Table 1 below lists the commercially available POMs marketed with trademark Ultraform® by BASF SE, produced by the circulatory tray process and corresponding to component B1.

TABLE 1

| | Butylal | | | | |
|---|---|---|---|---|---|
| | content | Mn | Mw | | MFI |
| Name | [% by wt.] | [×10³ g/mol] | [×10³ g/mol] | Mw/Mn | [cm³/10 min] |
| H2320 | 0.1 | 27 | 209 | 7.7 | 2.1-2.4 |
| N2320 | 0.17 | 26 | 154 | 5.9 | 7.3-7.7 |
| S2320 | 0.2 | 25 | 135 | 5.4 | 9-12 |
| W2320 | 0.25 | 22 | 109 | 5.0 | 23-25 |
| Z2320 | 0.35 | 23 | 97 | 4.2 | 42-43 |

The POM used for the Catamold process described in the introduction corresponds to Ultraform® Z2320, which is produced with 0.35% by weight butylal content.

The proportion of butylal was then increased in order to reduce molecular weight. The proportion of butanediol comonomer was in each case unchanged at 2.7% by weight, based on the polymer. Initiator concentration was 0.05 ppm, based on the monomers.

Table 2 below collates the results.

TABLE 2

| | Butylal, | | Mn | | Mw/ | | Thermal |
|---|---|---|---|---|---|---|---|
| | % by | Induction | [g/ | Mw | Mn | Extraction | stability, |
| Ex. | wt. | time | mol] | [g/mol] | [—] | [%] | Stab. [%] |
| 1 | 3 | 8 | 6080 | 15800 | 2.4 | 7.23 | 4.5 |
| 2 | 4 | 7 | 5350 | 12700 | 2.4 | 3.56 | 4.3 |
| 3 | 4.5 | 9 | 4700 | 11000 | 2.4 | 1.8 | 3.8 |

### Rheology Investigations

Rheology investigations were carried out on the POM of the invention as in Example in Table 2. For this, a plate-on-plate rheometer was used at 190° C., and dynamic viscosity was determined as a function of shear rate.

Table 3 below collates the results.

TABLE 3

| | | First measurement | | After restart | After restart/ |
|---|---|---|---|---|---|
| | Mw | H₀* | h*_{(@ w~10 rad/s)} | h*_{(@ w~10 rad/s)} | first measure- |
| Specimen/Ex. | [×10³ g/mol] | [Pa-s] | [Pa-s] | [Pa-s] | ment (%) |
| 1 | 15.8 | 0.3 | 0.2 | 0.2 | −16.6 |
| 2 | 12.7 | 0.11 | 0.12 | 0.12 | −1.6 |
| 3 | 11 | 0.11 | 0.11 | 0.11 | 0.8 |

The oligomers of the invention have very low melt viscosity.

### Extrusion of POM Blends

Blends made of Ultraform® Z2320, component B1, with different proportions of low-molecular-weight POM oligomers from Table 2 were extruded at 190° C. for two minutes in a midi-extruder. The blends were likewise subjected to the above rheology measurements and to DSC (differential scanning calorimetry). Table 4 below collates the resultant blend properties.

TABLE 4

| | High-molecular- | | | | | |
|---|---|---|---|---|---|---|
| | weight POM B1 | | Oligomers B2 | | | |
| | | Mw | | Mw | [% by | Blend properties |
| Ex. | Grade | [kg/mol] | Ex. | [g/mol] | wt.] | Viscosity at 10 rad/s |
| REF | Z2320- | 86 | — | — | — | 100.7 |
| | 0035 | | | | | |
| 4 | Z2320- | 86 | 2 | 12700 | 83 | 1.4 |
| 5 | 0035 | | | | 70 | 5.4 |
| 6 | | | | | 60 | 12.2 |
| 7 | | | | | 50 | 24.6 |
| 8 | | | 3 | 11000 | 83 | 1.3 |
| 9 | | | | | 70 | 4.9 |
| 10 | | | | | 60 | 10 |
| 11 | | | | | 50 | 23.2 |
| REF | S2320- | 130 | — | — | — | 884.2 |
| | 003 | | | | | |
| 12 | S2320- | 130 | 3 | 11000 | 83 | 4 |
| 13 | 003 | | | | 70 | 12.6 |
| 14 | | | | | 60 | 10.2 |
| 15 | | | | | 50 | 87.1 |
| REF | H4320- | 208 | — | — | — | 4473.3 |
| | 006 | | | | | |
| 16 | H4320- | 208 | 3 | 11000 | 83 | 17.2 |
| 17 | 006 | | | | 70 | 63.4 |
| 18 | | | | | 60 | 212 |
| 19 | | | | | 50 | 552.6 |

The results show that with use of component B2 the viscosity change after restart is markedly smaller than for the comparative compositions. The POM blend using the low-molecular-weight POM of the invention is therefore markedly stabler than the comparative blends.

The low-molecular-weight POMs of component B2 can therefore be used with particular advantage as viscosity-modifying additive for polyoxymethylene homo- or copolymers with a weight-average molar mass of at least 50 000 g/mol of component B1.

The low-molecular-weight POMs of the invention are chemically and mechanically stable and do not reduce either overall strength or overall mechanical properties on mixing with high-molecular-weight POM of component B1. The viscosity of the high-molecular-weight POM can be reduced greatly here, and this effect is retained through a plurality of melt passes.

No formaldehyde vapor is evolved, and the POM blend remains solid, and it is therefore also possible to carry out the traditional Catamold production process with the POM blends.

These advantages are not achieved with the use of compounds of even lower molecular weight, for example POM dimethyl ethers, such as Me-O—(CH₂O)₄-Me. The advantages mentioned are achieved only by the specific use of the POM of the invention.

In another experiment, in Example 11, blends made of Ultraform® Z2320 with low-molecular-weight POM oligomer from Example 3 were mixed in a mini extruder in a ratio by weight of 50:50. 3 specimens were mixed here for one minute, 2 minutes and, respectively, 5 minutes.

Size-exclusion chromatography was then used in each case to plot a molecular-weight profile for the blend.

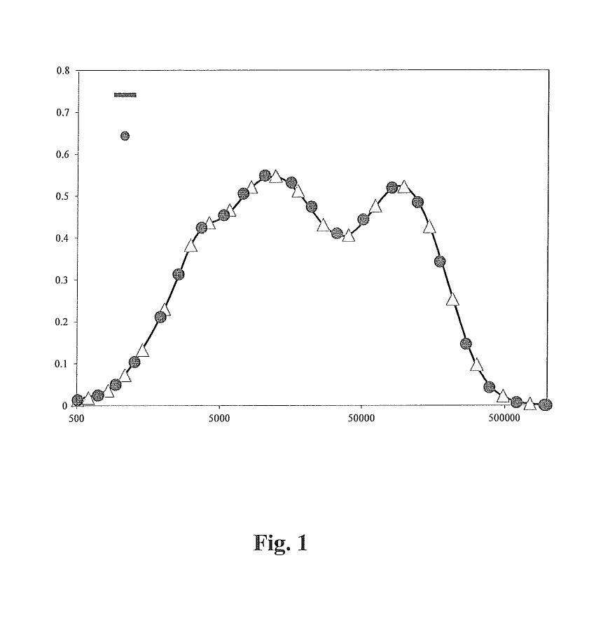

FIG. 1 attached shows the dependency of the size-exclusion-chromatography (SEC) detector signal in arbitrary units when plotted against molar mass in g/mol. The continuous line shows the molar mass distribution for mixing for one minute, the triangles show the molar mass distribution after mixing for 2 minutes, and the circles show the molar mass distribution for a mixing time of 5 minutes.

The molar mass distribution was found to remain the same for the three mixing times, indicating stability of the polymer blend. The bimodal molar mass distribution resulting from the blend polymers is moreover retained. There is therefore no molar mass equilibration through transacetalization.

It can therefore be stated that the bimodal molar mass distribution of the POM blends is retained even after thermal stress and that there is a major reduction in shear viscosity, and that processing properties are therefore markedly improved. The improved flowability in particular means that long flow paths and low wall thicknesses can also be tolerated in the injection-molding process, with no impairment of the result.

In contrast to other flow improvers, no phase separation occurs under shear when the POM oligomers are added, and neither therefore does any exudation of the flow improver occur which in turn would cause deposits in the mold.

The combination of low-molecular-weight POM with high-molecular-weight POM does not make the moldings brittle, but gives them high strength.

The stability in the melt makes the POM blends advantageously suitable for the Catamold® process for injection molding of metal powder or of ceramic powder. In this process, the POM molding compositions are subjected to three melting and shearing procedures, during mixing of the two polymer components, during introduction of the metal power or ceramic powder, and finally during injection molding. Further thermal stress occurs during return and reuse of parts of the injection-molded products, for example the sprues. This is where the advantages mentioned for the POM systems of the invention become apparent.

### Flow Performance of Metal-Powder-Filled POM Blends

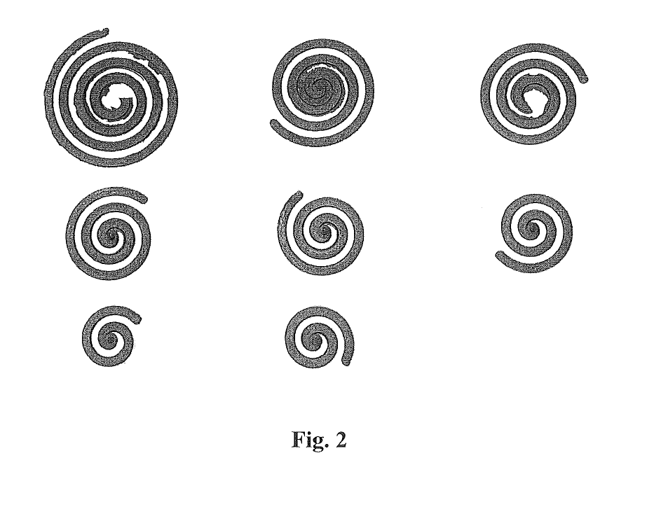

60% by volume of stainless steel metal powder (stainless steel 17-4PH with typical powder particle size distribution D₁₀<3 μm, D₅₀<8 μm, D₉₀<21 μm) were incorporated into a blend made of low-molecular-weight POM component B2 of example 3 and high-molecular-weight POM component B1 Z2320-003, with use of a kneader. Flow spirals were produced by injection molding in order to study the flow performance of the metal-powder-filled POM blends. FIG. 2 shows images of the resultant spirals.

The spirals in FIG. 2 here show, in the first row from the left-hand side to the right-hand side, 100% of POM from example 3 (spiral length>100 cm); 90% of POM from example 3+10% of Z2320-003 (spiral length about 70 cm); 80% of POM from example 3+20% of Z2320-003 (spiral length about 62 cm).

The middle row shows, from the left-hand side to the right-hand side, 70% of POM from example 3+30% of Z2320-003 (spiral length about 48 cm); 60% of POM from example 3+40% of Z2320-003 (spiral length about 42 cm); 50% of POM from example 3+50% of Z2320-003 (spiral length 34 cm).

The final row shows, from the left-hand side to the right-hand side, exclusively Z2320-003 (spiral length about 19 cm); Z2320-003+conventional flow improver (spiral length 24 cm).

A clear rise in the flow spiral length is apparent as the concentration of low-molecular-weight POM increases.

The use of the low-molecular-weight POM permits the production of metal binders with very good flow performance (high flow). It also permits the use of higher concentrations of metal powder. Various metal-powder-binder systems were produced and studied. Table 5 shows the results obtained. Again, Z2320-003 was used as high-molecular-weight POM component B1 (100, 60, 50, and 40% by weight, based on the POM binder).

TABLE 5

| | Content of | | | | |
|---|---|---|---|---|---|
| | low-molecular- | Metal | | | |
| | weight POM | powder | PolyBUFO- | MFI | Flow |
| | (example 3) | content | content | (g/10 | spirals |
| Example | (% by wt.) | (% by vol.) | (% by wt.) | min) | (cm) |
| REF | 0 | 60 | 1.78 | | 26 |
| K84189 | 40 | 60 | 0.83 | 1429 | 36 |
| K84188 | 50 | 60 | 0.83 | 1892 | 39 |
| K84184 | | 60 | 0.83 | 2625 | 40 |
| K83634 | | 66 | 0.58 | 598 | 22 |
| K83829 | 60 | 63 | 0.80 | 1576 | 38 |
| K83777 | | 66 | 0.58 | 344 | 15 |
| K83927 | | | 0.58 | 925 | 24 |
| K83539 | | | 1.85 | 1048 | 23 |
| K83255 | | 69 | 1.86 | 555 | 12 |

PoIyBUFO: polybutanediol formal with weight-average molecular weight (M_{W}) from 18 000 to 35 000; content based on entire POM binder.

The possibility in the invention of increasing the metal powder loading of the POM binders leads to improved tolerance ranges in the metal moldings finally obtained, since there is less organic binder that has to be burnt away before sintering.

1-15. (canceled)

16. A thermoplastic composition comprising
from 10 to 90% by weight of a polyoxymethylene homo- or copolymer with a weight-average molar mass (M_{W}) in the range from 50 000 to 400 000 g/mol as component B1 and
from 10 to 90% by weight of a polyoxymethylene copolymer with a weight-average molar weight (M_{W}) in the range from 5000 to 15 000 g/mol as component B2 derived to an extent of at least 90% by weight, based on the polymer, from trioxane and butanediol formal as monomers, with a proportion of butanediol formal, based on the polymer, in the range from 0.5 to 4% by weight.

17. The composition according to claim 16, wherein the weight-average molar mass (M_{W}) of component B2 is from 6000 to 9000 g/mol, and that of component B1 is from 70 000 to 300 000 g/mol.

18. The composition according to claim 16, wherein
from 10 to 90% by weight of a polyoxymethylene copolymer with a weight-average molar weight (M_{W}) in the range from 5000 to 15 000 g/mol as component B2 derived to an extent of at least 90% by weight, based on the polymer, from trioxane and butanediol formal as monomers, with a proportion of butanediol formal, based on the polymer, in the range from 2.5 to 3% by weight,
the weight-average molar mass (M_{W}) of component B2 is from 7000 to 7500 g/mol, and that of component B1 is from 95 000 to 210 000 g/mol.

19. The composition according to claim 16, wherein the number-average molar mass (Mₙ) of component B2 is from 3000 to 6000 g/mol.

20. The composition according to claim 16, wherein the ratio M_{W}/Mₙ for component B2 is in the range from 1.5 to 3.0.

21. The composition according to claim 18, wherein the number-average molar mass (Mₙ) of component B2 is from 3500 to 4100 g/mol and the ratio M_{W}/Mₙ for component B2 is in the range from 1.5 to 2.45.

22. The composition according to claim 16, wherein at least 90% by weight of component B1, based on the polymer, derive from trioxane and optionally butanediol formal as monomers, with a proportion of butanediol formal, based on the polymer, in the range from 1 to 5% by weight.

23. The composition according to claim 16, wherein production of the polymer of component B2 uses, based on the polymer, from 3.75 to 4.25% by weight, of methylal, or an equimolar amount of another di(C₁₋₆-alkyl) acetal, concomitantly as regulator.

24. The composition according to claim 21, wherein at least 90% by weight of component B1, based on the polymer, derive from trioxane and butanediol formal as monomers, with a proportion of butanediol formal, based on the polymer, in the range from 2.5 to 3% by weight and the production of the polymer of component B2 uses, based on the polymer, from 3.9 to 4.1% by weight, of methylal, or an equimolar amount of another di(C₁-C₆-alkyl) acetal, concomitantly as regulator.

25. A process for producing the thermoplastic composition according to claim 16 which comprises separate production of components B1 and B2 in each case by polymerizing trioxane and optionally comonomers in the presence of at least one cationic initiator and of at least one di(C₁₋₆-alkyl) acetal as regulator, and then mixing components B1 and B2.

26. A process for producing a flowable polyoxymethylene copolymer which comprises separate production of components B1 and B2, these being as defined in claim 16, respectively by polymerizing trioxane and optionally comonomers in the presence of at least one cationic initiator and of at least one di(C₁₋₆-alkyl) acetal as regulator, and then mixing components B1 and B2 at a temperature in the range from 150 to 220° C. under a pressure in the range from 0.5 to 5 bar.

27. A molding composition for producing inorganic moldings, comprising, based on the total volume of the molding composition,
from 20 to 70% by volume of a sinterable pulverulent inorganic material selected from metals, metal alloys, metal carbonyls, metal oxides, metal carbides, metal nitrides, and mixtures thereof, as component A,
from 30 to 80% by volume of the thermoplastic composition according to claim 16, and
from 0 to 5% by volume of a lubricant and/or dispersing agent as component C,
where the total volume of components A to C do not exceed 100% by volume.

28. The molding composition according to claim 27, wherein the particle size of at least 65% by volume of component A is at most 5 μm and the particle size of the remainder of component A is at most 10 μM.

29. A process for producing the molding composition according to claim 27 which comprises melting component B at a temperature in the range from 150 to 220° C. to obtain a melt stream and metering components A and optionally C into the melt stream of component B.

30. A process for producing metallic or ceramic moldings which comprises injection molding or extruding the molding composition according to claim 27 to give a green product, then removing binder from the green product to give a brown product, and then sintering the brown product.

31. The process according to claim 30, wherein the removal of binder is achieved by treating the green product with a gaseous acid-containing atmosphere at a temperature in the range from 20 to 180° C. for from 0.1 to 24 hours.

32. A molding produced from the molding compositions according to claim 27.

33. A flowable polyoxymethylene copolymer obtainable by the process according to claim 26.
